(19) United States
(12) Patent Application Publication
(10) Pub. No.: US 2017/0034766 A1
(43) Pub. Date: Feb. 2, 2017

(54) SYSTEM AND METHOD FOR DISABLING FUNCTIONS OF MOBILE COMMUNICATION DEVICE

(71) Applicants: George Christ, Garden City, NY (US); Timothy Christ, Garden City, NY (US)

(72) Inventors: George CHRIST, Garden City, NY (US); Timothy CHRIST, Garden City, NY (US)

(21) Appl. No.: 15/302,224

(22) PCT Filed: Apr. 8, 2015
(86) PCT No.: PCT/US2015/024828

§ 371 Date: Oct. 6, 2016

Related U.S. Application Data
(60) Provisional application No. 61/977,308, filed on Apr. 9, 2014.

(51) Int. Cl. H04W 48/02; H04L 29/06; G06K 19/06; G06K 7/10; H04W 12/06; F16H 61/22

(52) U.S. Cl. CPC H04W 48/02; H04W 12/06; F16H 61/22; G06K 19/06009; G06K 7/1095; H04L 63/0876; H04W 4/046

(57) ABSTRACT

A systems and method for disenabling one or more functions of a mobile device when a user of the mobile device is operating a motor vehicle is provided. The device has a signal transceiver for receiving and sending signals with respect to the mobile device and the motor vehicle, a memory for storing data, a display for displaying information and providing a user interface and a hardware processor. The processor is used to authenticate the mobile device to the motor vehicle, receive a request message indicating that the user intends to operate the motor vehicle, send a first instruction message to disable the functions of the mobile device, receive a confirmation message indicating that the functions of the mobile device have been disabled and send a second instruction message to the motor vehicle for allowing operation of the motor vehicle by the user.

### BACKGROUND

The present invention relates generally to a wireless communication system and method, and more particularly, to a system and method for selectively limiting or disabling one or more functions of a mobile communication device, particularly a mobile phone, during operation of a motor vehicle.

Texting and driving is in the news more and more these days. Accidents, state bans, new studies and statistics, more accidents . . . the list goes on and on. Recent studies have revealed that it is dangerous for a person to operate a motor vehicle while using a mobile communication device, such as a cell phone. Specifically, texting while driving is considered as distracted driving and dangerous because drivers would have to take their eyes off the road, a hand off the wheel, and their mind off of their driving. Most troubling: even with all the stories of tragic car accidents happening as a direct result of distracted driving, teens and adults are still texting at the wheel. Statistics show that most crashes occur three seconds after a distraction. Thus a driver's acts of checking messages, answering phone calls or texting when driving a motor vehicle can put the driver's life and the lives of the passengers, other motorists and even innocent pedestrians. Talking on the phone and texting has reached epidemic proportions. It startling to believe but texting while driving has now surpassed drinking and driving as the leading cause of death among teens, according to a new study. Statistics show that if a person is communicating by text while driving a vehicle, the person is 23 times more likely to crash.

Therefore, there is a need to limit or disable one or more functions of the mobile communication device of the driver, during the driver's operation of a motor vehicle.

### SUMMARY

According to an exemplary aspect of the present invention, a method for disenabling one or more functions of a mobile device prior to operating a motor vehicle by a user of the mobile device is provided. The method includes authenticating the mobile device to the motor vehicle; receiving a request message indicating that the user intends to operate the motor vehicle; sending a first instruction message to disable the functions of the mobile device; receiving a confirmation message indicating that the functions of the mobile device have been disabled; and sending a second instruction message to the motor vehicle for allowing operation of the motor vehicle by the user.

Optionally, the step of receiving the request message includes scanning a barcode shown on a display of the mobile device, wherein the barcode indicates that the user intends to operate the motor vehicle.

Optionally, the step of sending the first instruction message includes sending the first instruction message to the mobile device or a service provider associated with the mobile device to disenable the functions of the mobile device.

Optionally, the step of receiving the confirmation message includes receiving the confirmation message from the mobile device or a service provider associated with the mobile device.

Optionally, the step of sending the second instruction message includes sending the second instruction message to a controller of the motor vehicle, wherein the controller is configured to disengage a shift lever of the gear box of the motor vehicle to allow the user to change gear.

According to another exemplary aspect of the present invention, a device for disenabling one or more functions of a mobile device when a user of the mobile device is operating a motor vehicle is provided. The device includes a signal transceiver for receiving and sending signals with respect to the mobile device and the motor vehicle; a memory for storing data; a display for displaying information and providing a user interface; and a hardware processor. The processor is configured to: authenticate the mobile device to the motor vehicle; receive a request message indicating that the user intends to operate the motor vehicle; send a first instruction message for disabling the functions of the mobile device; receive a confirmation message indicating that the functions of the mobile device have been disabled; and send a second instruction message to the motor vehicle for allowing operation of the motor vehicle by the user.

Optionally, the hardware processor is also configured to scan a barcode shown on a display of the mobile device, wherein the barcode indicates that the user intends to operate the motor vehicle.

Optionally, the hardware processor is also configured to send the first instruction message to the mobile device or a service provider associated with the mobile device to disenable the functions of the mobile device.

Optionally, the hardware processor is also configured to receive the confirmation message from the mobile device or a service provider associated with the mobile device.

Optionally, the hardware processor is also configured to send the second instruction message to a controller of the motor vehicle, wherein the controller is configured to disengage a shift lever of the gear box of the motor vehicle to allow the user to change gear.

### BRIEF DESCRIPTION OF THE DRAWINGS

These and other features, aspects and benefits of the present invention will be made apparent with reference to the following specification and accompanying drawings, where like reference numerals refer to like features across the several views, and wherein:

FIG. 1 is a diagram showing a system for selectively disabling or enabling one or more functions of a mobile communication device;

FIG. 2 is a diagram showing hardware architecture of an interface device of the system of FIG. 1;

FIG. 3 is a flow chart showing steps for disabling one or more functions of the mobile communication device prior to operating a motor vehicle; and

FIG. 4 is a flow chart showing steps for restoring the one or more functions of the mobile communication device after completing operating the motor vehicle.

### DETAILED DESCRIPTION OF THE EMBODIMENTS

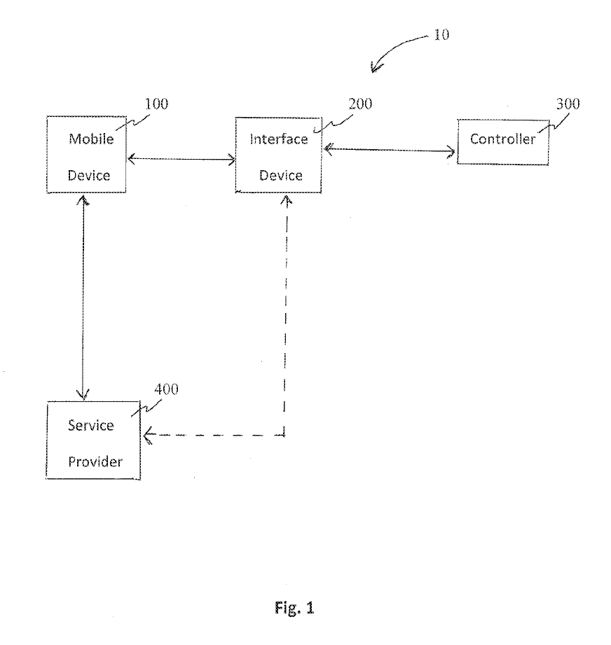

FIG. 1 shows a system 10 for selectively disabling or enabling certain functions, particularly a texting function, of a mobile communication device prior to operating a vehicle. The system 10 can also be used to restore the functions of the mobile device once the operation is completed.

The system 10 includes a mobile device 100, an interface device 200 and a controller 300. The mobile device 100 can be a cell phone, which provides functions including calling, texting and messaging, browsing internet, gaming and so on. The mobile device 100 communicates with a service provider 400 (such as a telecommunication service provider), through wireless communication, to ensure that these functions can be properly implemented by the mobile device 100. The interface device 200 is a preprogrammed hardware module or unit, which communicates with the mobile device 100 through wireless or wired communication to determine whether the functions of the mobile device 100 have been limited or disabled prior to operating the motor vehicle and/or whether the operation of the motor vehicle has been completed to enable the previously disabled functions of the mobile device 100. For that purpose, the interface device 200 is mounted at a proper location within the motor vehicle, wherein the interface device 200 can be easily accessed by the mobile device 100. For example, the interface device 200 can be mounted under the dashboard of the motor vehicle.

Additionally and optionally, the interface device 200 can also communicate with the service provider 400 to provide additional services or enhance the disabling/enabling operation of the mobile device 100. For example, the interface device 200 can communicate with the service provider 400 to authenticate the mobile device and/or to register the mobile device with respect to the motor vehicle. Alternatively, the service provider 400 can be involved in the process for determining whether the functions of the mobile device have been properly disabled or the operation of the motor vehicle has been fully completed, to enhance the security of the entire operation.

The controller 300 interacts with the interface device 200 through wireless or wired connection. The controller 300 is mounted at a suitable position within the motor vehicle. The controller 300 is configured to lock and/or unlock the motor vehicle upon receiving and reading instructions from the interface device 200. For example, the controller 300 can be configured to lock and/or unlock the gears of the motor vehicle by mechanically or electrically controlling the engagement and/or disengagement of the shift lever of the gear box of the motor vehicle. In operation, the controller 300 can disengage the shift lever to unlock the gears and thus, to allow the user to change the gear out of park after the interface device 200 has determined that certain functions of the mobile device 100 have been disabled, or engage the shift lever to lock the gears after the interface device 200 has determined that driving operation has been completed and/or the disabled functions of the mobile device 100 have been restored.

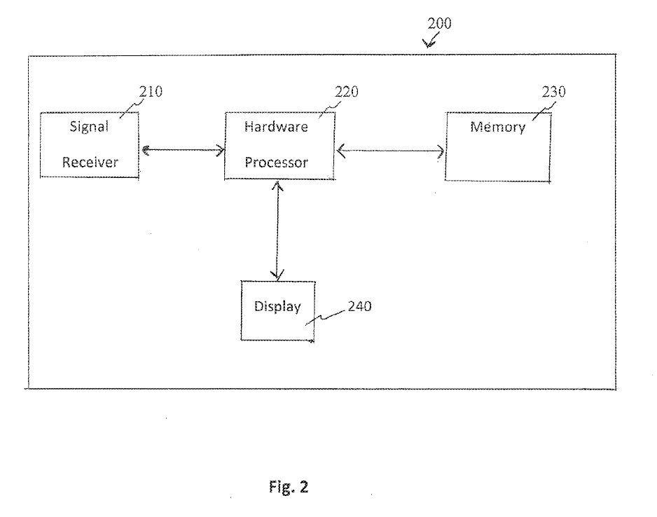

FIG. 2 is a block diagram showing the structural and functional modules of the interface device 200. The interface device 200 includes a signal transceiver 210, a hardware processor 220, a memory 230 and a display 240. The signal transceiver 210 can be in the form of an antenna, any suitable radio frequency circuit or any electro-optical circuit, which is capable of simultaneously receiving and sending signals. The hardware processor 220 is capable of maintaining database and implementing a predetermined algorithm. The hardware processor 220 also executes other computational activities of the interface device 200, such as executing instructions, decrypting messages and so on. The hardware processor 220 can process information obtained from the signal transceiver 210 and access the information stored in the memory 230. The display 240 can be an LCD for displaying related information and/or providing an interface to allow the user to interact with the interface device 200 by providing input and selection functions. The memory 230 can be any suitable read-only memory and/or random access memory depending on the data to be stored.

For example, the display 240 can further include an indicator light of green or red, for showing if the system has been enabled or disabled to drive the motor vehicle. The display 240 can also include an indicator light for showing if communication with the mobile device 100 is enable or disabled. Alternatively, the display 240 can include a single indicator light of green for showing that communication of the mobile device 100 has been disabled and the vehicle controller 300 has operated to allow the vehicle to operate.

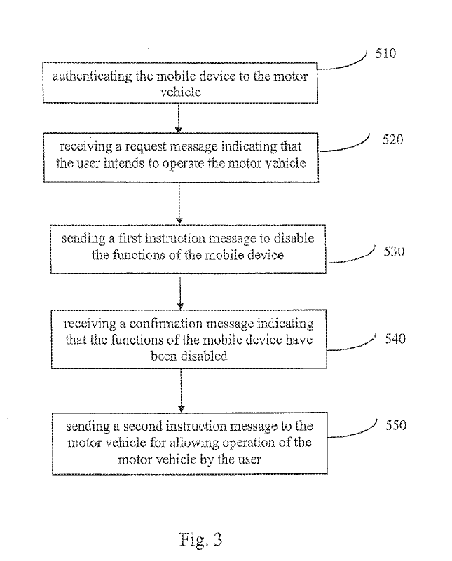

FIG. 3 is a flow chart illustrating a method 500 of limiting or disabling one or more functions of a mobile device prior to the operating a motor vehicle. The method 500 will be described with reference to the mobile device 100, the interface device 200 and the controller 300.

In step 510, the mobile device 100 is authenticated with respect to the motor vehicle. For example, the mobile device 100 can be pre-registered with the motor vehicle by any known methods; thus, only users of the registered mobile devices can operate the motor vehicle. A plurality of mobile devices can be pre-registered and later authenticated with respect to the motor vehicle. In this step, an encrypted request message generated by the mobile device 100 through a predetermined algorithm can be sent to the interface device 200. The interface device 200, upon receiving the request message, decrypts the request message and determines whether the mobile device is pre-registered with the motor vehicle. For example, a barcode or a QR (Quick Response) code can be decrypted from the request message and be subsequently compared with existing codes saved in the memory of the interface device 200 to judge whether there is a match. If no match can be found, the interface device 200 terminates communication with the mobile device 100, and as a result, the motor vehicle cannot be operated. If a match is found, the interface device 200 sends a reply message to the mobile device 100 and/or the service provider 400 associated with the mobile device 100, to enable additional communication with the mobile device 100 and/or the service provider 400 to allow operation of the motor vehicle. In addition, the motor vehicle cannot be operated if the user does not have a properly registered mobile device. Thus, in case the motor vehicle is stolen, it will not operate properly.

In step 520, the interface device 200 receives a request message indicating that the user intends to operate the motor vehicle. The request message can be generated and sent by the mobile device 100 upon receiving the reply message in step 510. The request message can be in the form of a barcode displayed on the display of the mobile device 100. The transceiver 210 of the interface device 200 can include a scanner for scanning the barcode and sending the barcode to the processor 220. Alternatively, the request message can be generated and sent by the service provider 400.

In step 530, the interface device 200 sends an instruction message to disable the functions of the mobile device 100. In this step, the instruction message can be sent to the mobile device 100, which decrypts the message and disables the functions of the mobile device 100 based on the decryption. Alternatively or additionally, the instruction message can be sent to the service provider 400 to disable the functions of the mobile device 100. To ensure disabling the functions of the mobile device, both the mobile device and the service provider receive the instruction message to disable the functions in a cooperative manner.

In step 540, the interface device 200 receives a confirmation message indicating that the functions of the mobile device 100 have been disabled. Similarly, in this step, the confirmation message can be sent by the mobile device and/or the service provider.

In step 550, the interface device 200 sends an additional instruction message to the motor vehicle for allowing the user to operate the motor vehicle. In this step, the instruction message is sent to the controller 300 mounted in the motor vehicle. The controller 300, upon receiving the instruction message, can disengage a shift lever of the gear box of the motor vehicle to allow the user to change the gear out of park.

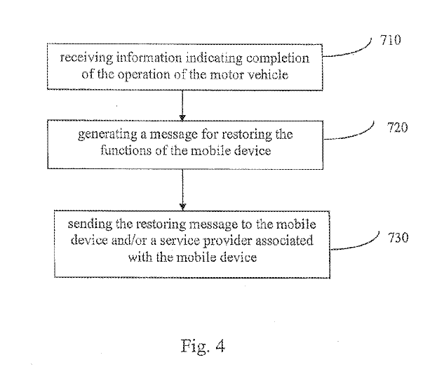

FIG. 4 is a flow chart illustrating a method 700 of restoring the functions of the mobile device 100 after the user has completed the operation of the motor vehicle. The method 700 will be described with reference to the mobile device 100, the interface device 200 and the controller 300.

After the user has completed the operation of the motor vehicle, the user stops the vehicle and changes the gear to park (for example, by moving the shift lever to park), which will actuate the controller 300 to lock the gear box of the motor vehicle. Once the gear box is locked, a signal, for confirming the completion of the operation and the locking of the gear box, is generated by the controller 300, which is sent to the interface device 200 for allowing restoring the functions of the mobile device 100.

In step 710, the interface device 200 receives the signal from the controller 300 indicating that the operation of the motor vehicle has been completed.

In step 720, the interface device 200 generates a restoring message for restoring the functions of the mobile device 100.

In step 730, the interface device 200 sends the restoring message to the mobile device 100 and/or the service provider 400. The functions of the mobile device 100 will be restored by the mobile device 100 and/or the service provider 400.

The system and method for limiting or disabling certain functions of a mobile device has been described as above. However, certain functions of the mobile device should not be disabled at any time, such as the emergency call function.

The system and method of the present disclosure illustrated above may be implemented and run on a general-purpose computer or special-purpose computer system. The computer system may be of any type of known or will be known systems and may typically include a processor, memory device, a storage device, input/output devices, internal buses, and/or a communications interface for communicating with other computer systems in conjunction with communication hardware and software and so on.

A computer program product may include any tangible or physical medium that can store data and/or computer instructions, and, for example, that can be read and/or be executed by a computer, machine or the like. Examples may include but are not limited to, memory devices (such as a random access memory (RAM), a read-only memory (ROM) and the like), discs, optical storage devices, and others.

The embodiments described above are illustrative examples and it should not be construed that the present disclosure is limited to these particular embodiments. Thus, various changes and modifications may be effected by one skilled in the art without departing from the spirit or scope of the disclosure as defined in the appended claims.

I claim:

1. A method for disenabling one or more functions of a mobile device prior to operating a motor vehicle by a user of the mobile device, the method comprising:
authenticating the mobile device to the motor vehicle;
receiving a request message indicating that the user intends to operate the motor vehicle;
sending a first instruction message to disable the functions of the mobile device;
receiving a confirmation message indicating that the functions of the mobile device have been disabled; and
sending a second instruction message to the motor vehicle for allowing operation of the motor vehicle by the user.

2. The method of claim 1, wherein the step of receiving the request message comprises scanning a barcode shown on a display of the mobile device, wherein the barcode indicates that the user intends to operate the motor vehicle.

3. The method of claim 1, wherein the step of sending the first instruction message comprises sending the first instruction message to the mobile device or a service provider associated with the mobile device to disenable the functions of the mobile device.

4. The method of claim 1, wherein the step of receiving the confirmation message comprises receiving the confirmation message from the mobile device or a service provider associated with the mobile device.

5. The method of claim 1, wherein the step of sending the second instruction message comprises sending the second instruction message to a controller of the motor vehicle, wherein the controller is configured to disengage a shift lever of the gear box of the motor vehicle to allow the user to change gear.

6. A device for disenabling one or more functions of a mobile device when a user of the mobile device is operating a motor vehicle, the device comprising:
a signal transceiver for receiving and sending signals with respect to the mobile device and the motor vehicle;
a memory for storing data;
a display for displaying information and providing a user interface; and
a hardware processor configured to:
authenticate the mobile device to the motor vehicle;
receive a request message indicating that the user intends to operate the motor vehicle;
send a first instruction message to disable the functions of the mobile device;
receive a confirmation message indicating that the functions of the mobile device have been disabled; and
send a second instruction message to the motor vehicle for allowing operation of the motor vehicle by the user.

7. The device of claim 6, wherein the hardware processor is also configured to scan a barcode shown on a display of the mobile device, wherein the barcode indicates that the user intends to operate the motor vehicle.

8. The device of claim 6, wherein the hardware processor is also configured to send the first instruction message to the mobile device or a service provider associated with the mobile device to disenable the functions of the mobile device.

9. The device of claim 6, wherein the hardware processor is also configured to receive the confirmation message from the mobile device or a service provider associated with the mobile device.

10. The device of claim 6, wherein the hardware processor is also configured to send the second instruction message to a controller of the motor vehicle, wherein the controller is configured to disengage a shift lever of the gear box of the motor vehicle to allow the user to change gear.
